(19) United States
(12) Patent Application Publication
(10) Pub. No.: US 2026/0180872 A1
(43) Pub. Date: Jun. 25, 2026

(54) THREE-LAYER ARTIFICIAL INTELLIGENCE DETECTION SYSTEM

(71) Applicant: HARBOR TECHNOLOGY SOLUTIONS CO., LTD., Taipei City (TW)

(72) Inventor: Hung-Yi LU, Taipei City (TW)

(21) Appl. No.: 19/000,594

(22) Filed: Dec. 23, 2024

(51) Int. Cl. H04L 41/16

(52) U.S. Cl. CPC H04L 41/16

(57) ABSTRACT

A three-layer AI detection system includes at least one sensor, a gateway, and a server platform. The sensor senses a device and acquires a sensing signal data of the device. The sensor includes a first AI module and a first communication module. The gateway includes a second AI module and a second communication module. The server platform includes a third AI module, a data storage management module, and a third communication module. The sensor, the gateway, and the server platform communicate with each other through the first, second, and third communication modules. The multi-layer AI technology is used to process, manage, and execute received detection data and related programs in layers to achieve benefits: decentralized hierarchical processing, high efficiency, high speed, low cost, easy to develop, continuous and automatic learning and updating of AI models, and can process a large amount of data in real time and synchronously.

### TECHNICAL FIELD OF THE INVENTION

The present disclosure relates to a detection system, and more particularly to a three-layer artificial intelligence detection system that can process, manage, and execute received detection data and related programs in layers, and can process a large amount of data in real time and synchronously to increase data processing performance.

### DESCRIPTION OF RELATED ART

The statements in this section merely provide background information related to the present disclosure and do not necessarily constitute prior art.

AIOT (Artificial Intelligence of Things) is the introduction of artificial intelligence (AI) systems into IoT (Internet of Things) technology. In the past, IoT technology applications have created close connections between multiple devices (equipment), such as common automation, remote control, serial connections between devices, etc., which are all IoT application categories.

As AIOT smart network technology gradually develops and matures, there are more and more innovative applications of AIoT smart networks in industry and daily life. Since AIOT has the ability to learn from external data and make predictive analysis and judgement decisions, it can continuously evolve through data accumulation and provide better customized services.

Currently, AIoT smart network technology is applied to equipment (device) detection systems, and its structure broadly includes the perception layer, the network layer, and the application layer. Specifically, the perception layer uses sensors to acquire sensing signal data of the devices anytime and anywhere. The network layer uses a gateway to provide an intermediary for transmitting sensing signal data and sending commands so as to accurately transmit device information. The application layer stores, analyzes, and reuses data by using servers to increase management efficiency or provide better services.

Although the above-mentioned conventional equipment detection system can collect a large amount of information and data from the equipment, improve the effect of analysis and prediction, and then predict equipment failures to reduce the impact of faulty repairs, it usually relies on servers to analyze and process a large amount of collected big data and information to implement intelligent control of the devices. Therefore, the server has to bear a great burden in data reception, processing, and control, thereby resulting in lower efficiency and slower data processing speed of the whole system.

### SUMMARY OF THE INVENTION

An objective of the present disclosure is to provide a three-layer artificial intelligence (AI) detection system that can process, manage, and execute received detection data and related programs in layers, and can process a large amount of data in real time and synchronously to increase data processing performance.

In order to achieve the above-mentioned objective, the three-layer AI detection system includes at least one sensor, a gateway, and a server platform. The sensor senses a device and acquire a sensing signal data of the device; the sensor includes a first AI module and a first communication module; the first AI module performs one of the processing of the sensing signal data, the basic determination of the sensing signal data, and the operation of an OTA. The gateway includes a second AI module and a second communication module; the second AI module performs one of the collections of the sensing signal data, the cleaning of the sensing signal data, the advanced determination of the sensing signal data, and the management of the OTA; the gateway and the first communication module are connected and communicate with each other through the second communication module. The server platform includes a third AI module, a data storage management module, and a third communication module; the third AI module and the data storage management module perform one of the collections of big data, the trend analysis, the device management, the customer management, and the recording of the OTA; the server platform and the second communication module are connected and communicate with each other through the third communication module.

In the present disclosure, a multi-layer AI technology is used to process, manage, and execute received detection data and related programs in layers.

Overall, the present disclosure has the following benefits:
(1) decentralized hierarchical processing;
(2) high efficiency;
(3) high speed;
(4) low cost;
(5) easy to develop;
(6) continuous and automatic learning and updating of AI models;
(7) can process a large amount of data in real time and synchronously.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a schematic diagram of a three-layer artificial intelligence (AI) detection system according to the present disclosure.

FIG. 2 is a structure block diagram of the three-layer AI detection system according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

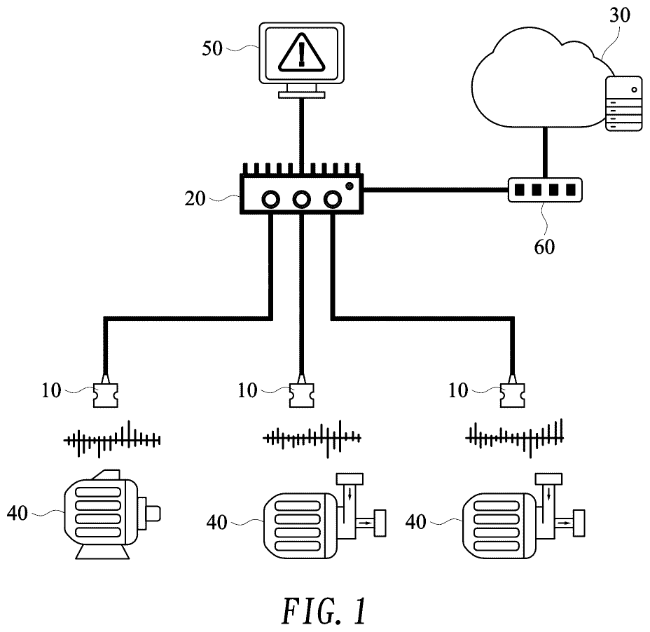

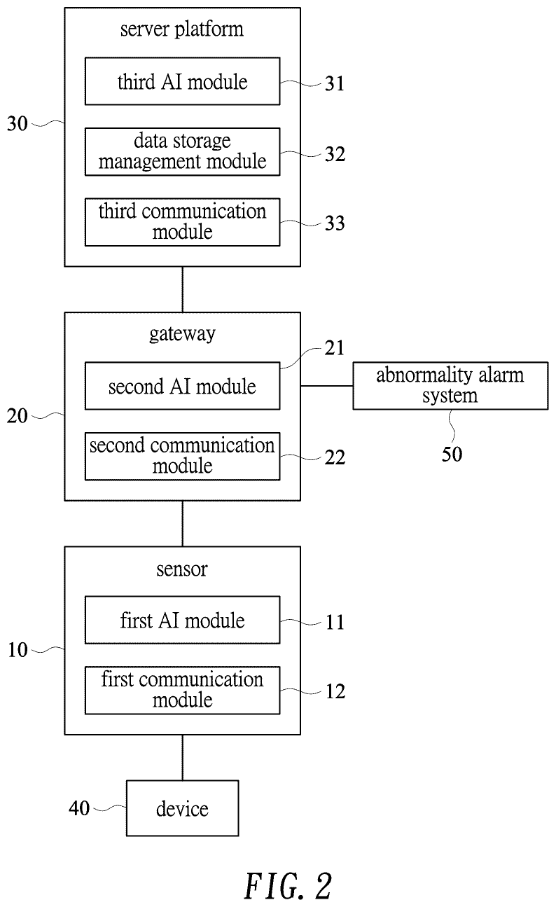

Please refer to FIG. 1, which shows a schematic diagram of a three-layer artificial intelligence (AI) detection system according to the present disclosure, and FIG. 2, which shows a structure block diagram of the three-layer AI detection system according to the present disclosure.

As shown in FIG. 1 and FIG. 2, the three-layer AI detection system includes at least one sensor 10, a gateway 20, and a server platform 30, which will be described in detail below.

The sensor 10 is used to sense a device 40 and acquire a sensing signal data (or datum) of the device 40. The sensor 10 includes a first AI module 11 and a first communication module 12. The first AI module 11 is used to perform one of the processing of the sensing signal data, the basic determination of the sensing signal data, and the operation of the OTA (Over-the-Air).

In particular, the first AI module 11 performs the processing of the sensing signal data including:
1. Data rationalization. If there are abnormal and unreasonable values in the sensing signal data, such as when most of the high and low values in a region are within a range, if a value that is particularly higher or lower than the range suddenly appears, or if a region with no sensed numerical data at all suddenly appears, and it is determined that erroneous sensed value data has obviously occurred, the first artificial AI module 11 can automatically provide corrections to rationalize such data.
2. Data noise reduction. The noise in the sensing signal data is removed.

The OTA for the purpose of the embodiment refers to the data transmission or the downing and updating of online software through wireless communication technology without the use of a physical connection.

The gateway 20 includes a second AI module 21 and a second communication module 22. The second AI module 21 is used to perform one of the collections of the sensing signal data, the cleaning of the sensing signal data, the advanced determination of the sensing signal data, and the management of the OTA. The gateway 20 and the first communication module 12 are connected and communicate with each other through the second communication module 22.

The server platform 30 includes a third AI module 31, a data storage management module 32, and a third communication module 33. The third AI module 31 and the data storage management module 32 are used to perform one of the collections of big data, the trend analysis, the device management, the customer management, and the recording of the OTA. The server platform 30 and the second communication module 22 are connected and communicate with each other through the third communication module 33.

In one embodiment, the device 40 is one of a motor, a pump, and a high-voltage equipment. In one embodiment, the sensing signal data is one of sound, vibration, electromagnetic wave, and current.

In one embodiment, the gateway 20 is an edge gateway.

In one embodiment, the first communication module 12, the second communication module 22, and the third communication module 33 are connected and communicate with each other through a wired manner or a wireless manner.

In one embodiment, the first communication module 12, the second communication module 22, and the third communication module 33 are connected and communicate with each other through a wired manner or a wireless manner.

In one embodiment, the third communication module 33 and the second communication module 22 are connected and communicate with each other through an Ethernet, a WiFi, a Bluetooth, or an RF (radio frequency).

In one embodiment, the server platform 30 is one of a cloud server and a local server.

In one embodiment, the gateway 20 is connected to an abnormality alarm system 50 for sending a warning message when abnormal operation of the device 40 is detected.

Accordingly, the device 40 can be further commanded to be automatically shut down by a connection signal control to prevent the device 40 from continuing to operate in an abnormal state.

In one embodiment, a switch is connected between the gateway 20 and the server platform 30 for network bridging.

The embodiments of the three-layer AI detection system of the present disclosure are disclosed above, and hereinafter the features and effects of the present disclosure are introduced as follows.

In the present disclosure, a multi-layer AI technology is used to process, manage, and execute received detection data and related programs in layers.

The sensor 10 of the present disclosure can perform preliminary AI data processing at the perception layer by the first AI module 11, such as noise reduction of the sensing signal data and basic determination of the sensing signal data, which can then be applied to the sensing of different devices 40. For example, if the sensor 10 is originally used for the detection of motor equipment, but is instead used for the detection of high-voltage equipment, the first AI module 11 can determine that the originally detected device 40 has changed to another device 40 by sensing the difference in current sensing signal data. Furthermore, with an automatic OTA update, AI sensing models for different devices are generated. Therefore, the sensing signal data of different devices 40, such as sound, vibration, electromagnetic wave, current, etc., may be applied to the present disclosure.

One of the advantages (benefits) of the present disclosure is that:

The sensing signal data of the device 40 sensed by the sensor 10 can be continuously uploaded to the server platform 30 through the gateway 20, and can be stored, analyzed, and managed.

When the same device 40 is used or operated for a period of time, or the device 40 ages, the sensing signal data generated by the device 40 will be different. In this condition, the original AI sensing model of the sensor 10 is not applicable. Therefore, the server platform 30 of the present disclosure can immediately determine that there has been a change in the sensing signal data of the device 40 such that the current AI sensing model of the sensor 10 is no longer applicable. Accordingly, the OTA automatically updates the AI sensing model of the sensor 10 to increase the effect of the analysis and prediction and to accurately predict whether the device 40 is ageing and about to fail.

Another of the advantages (benefits) of the present disclosure is that:

When a plurality of sensors 10 respectively sense devices 40 having the same attributes, for example, the devices 40 are pumps of the same make and model, if one of the pumps frequently fails, the sensing data of the failure is uploaded to the server platform 30. Since the server platform 30 of the present disclosure can receive the sensing signal data of all the devices 40, and store, analyze, and manage these sensing signal data, even though other devices have no failures but are devices having the same attributes, the server platform 30 can also provide better and newer AI sensing models to those non-faulty devices 40 based on the original stored fault sensing data to increase the effect of analysis and prediction.

To further explain, the gateways 20 may be configured across countries and regions, for example, if one gateway 20 is in Taiwan and another gateway 20 is in the United States. When the device 40 in Taiwan fails, the server platform 30 can provide better and newer AI sensing models to the non-faulty devices 40 in the United States based on the stored fault sensing data of the device 40 in Taiwan. Therefore, the present disclosure can collect and analyze big data through the server platform 30. That is, if different or various fault conditions occur in the devices 40 located in Taiwan, the United States, Japan, Europe and other countries and regions, the fault sensing data of the devices 40 in different countries can be uploaded to the server platform 30 through the gateway 20, and these are consistently collected, analyzed, and predicted. Accordingly, the better and newer AI sensing models for various fault conditions of the device 40 are provided through the OTA to all gateways 20 and sensors to increase the effect of the analysis and prediction.

Further, another of the advantages (benefits) of the present disclosure is that:

The sensor 10 transmits the sensing signal data to the gateway 20, and the gateway 20 can perform advanced AI data processing at the network layer through the second AI module 21.

The gateway 20 can transmit the sensing signal data of the sensor 10 to the server platform 30. When the server platform 30 has the better and newer AI sensing models and the AI sensing models are determined, the OTA can assign and transmit the determined AI sensing models to appropriate and required sensors 10 through the gateway 20. The gateway 20 can monitor whether the AI sensing models transmitted to the sensor 10 have been updated completely and successfully.

In addition to performing OTA management, the gateway 20 can also store the sensing signal data and transmit the sensing signal data to the server platform 30 so that the server platform 30 has the sensing signal data of all the sensors 10. In the unlikely event that data is lost or damaged on the server platform 30, the gateway 20 can be reused to transmit the sensing signal data to the server platform 30 again so that the server platform 30 can acquire the sensing signal data again.

The server platform 30 can connect a plurality of gateways 20 by information to receive data transmitted from the gateways 20. Since the gateways 20 are configured across countries and regions and each gateway 20 can also be connected to a plurality of sensors 10, the server platform 30 can receive data transmitted from a plurality of gateways 20 and a plurality of sensors 10. Therefore, the server platform 30 can perform big data collection and provide trend analysis reports on these sensed data by the third AI module 31, and provide customized device management and customer management according to customer requirements and levels such as subscription and membership. Accordingly, the AI models of the gateways 20 and the plurality of sensors 10 can be continuously updated according to the requirements through the OTA so as to increase the efficiency of device management and provide better device detection services to customers.

Overall, the present disclosure has the following benefits:
(1) decentralized hierarchical processing;
(2) high efficiency;
(3) high speed;
(4) low cost;
(5) easy to develop;
(6) continuous and automatic learning and updating of AI models;
(7) can process a large amount of data in real time and synchronously.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A three-layer artificial intelligence (AI) detection system, comprising:
at least one sensor configured to sense a device and acquire a sensing signal data of the device; the sensor comprising a first AI module and a first communication module; the first AI module configured to perform one of the processing of the sensing signal data, the basic determination of the sensing signal data, and the operation of an OTA,
a gateway comprising a second AI module and a second communication module; the second AI module configured to perform one of the collections of the sensing signal data, the cleaning of the sensing signal data, the advanced determination of the sensing signal data, and the management of the OTA; the gateway and the first communication module connected and communicate with each other through the second communication module, and
a server platform comprising a third AI module, a data storage management module, and a third communication module; the third AI module and the data storage management module configured to perform one of the collections of big data, the trend analysis, the device management, the customer management, and the recording of the OTA; the server platform and the second communication module connected and communicate with each other through the third communication module.

2. The three-layer AI detection system as claimed in claim 1, wherein the device is one of a motor, a pump, and a high-voltage equipment; the sensing signal data is one of sound, vibration, electromagnetic wave, and current.

3. The three-layer AI detection system as claimed in claim 1, wherein the gateway is an edge gateway.

4. The three-layer AI detection system as claimed in claim 1, wherein the first communication module, the second communication module, and the third communication module are connected and communicate with each other through a wired manner or a wireless manner.

5. The three-layer AI detection system as claimed in claim 1, wherein the third communication module and the second communication module are connected and communicate with each other through an Ethernet, a WiFi, a Bluetooth, or an RF.

6. The three-layer AI detection system as claimed in claim 1, wherein the server platform is one of a cloud server and a local server.

7. The three-layer AI detection system as claimed in claim 1, wherein the gateway is connected to an abnormality alarm system for sensing a warning message when abnormal operation of the device is detected.

8. The three-layer AI detection system as claimed in claim 1, wherein a switch is connected between the gateway and the server platform for network bridging.
